(19) United States
(12) Patent Application Publication
(10) Pub. No.: US 2019/0035565 A1
(43) Pub. Date: Jan. 31, 2019

(54) SYSTEME DE CAME COMPORTANT AU MOINS UN MODULE MOBILE DE COMMANDE D'UN DISPOSITIF ACTIONNAIRE

(71) Applicant: BERNARD CONTROLS, GONESSE (FR)

(72) Inventors: Ivan DAJIC, AMY (FR); Romain GUILLAUME, NIORT (FR)

(21) Appl. No.: 15/716,611

(22) Filed: Sep. 27, 2017

(30) Foreign Application Priority Data
Jul. 27, 2017 (FR) 17 57 159

(51) Int. Cl. H01H 3/42

(52) U.S. Cl. CPC H01H 3/42; F16H 1/16

(57) ABSTRACT

A control cam system including at least one moving cam module for controlling an actuator device, in particular an electrical contact, having an end-of-travel position which is adjustable using a gear device. The module includes a base, secured to rotate with a rotating shaft, and a cam mounted so as to be adjustable in angular position on the base. The gear device includes a worm screw mounted on the base and meshing with teeth associated with the cam so that rotating the screw causes a change in the angular position of the cam on the base.

### FIELD OF THE INVENTION

The invention relates to a cam system including at least one moving module for controlling an actuating device, in particular an electric contact, the end-of-travel position of which is adjustable using a gear device.

### BACKGROUND

Systems of this type, which are known, have the major drawback of having a complex structure and being difficult to manipulate.

### SUMMARY OF THE INVENTION

The invention aims to offset this drawback.

To achieve this aim, the system according to the invention is characterized in that it comprises a base device secured in rotation with a rotating shaft and a cam mounted adjustable in angular position on the base and in that the adjusting device comprises a worm screw mounted on the base and that meshes with teeth associated with the cam so that rotating the screw causes a change in the angular position of the cam on the base.

### BRIEF DESCRIPTION OF DRAWING FIGURES

The invention will be better understood, and other aims, features, details and advantages thereof will appear more clearly, during the following explanatory description done in reference to the appended drawings, provided solely as an example illustrating one embodiment of the invention and in which:

FIG. 1 is a perspective view of a cam system according to the invention, which comprises four superimposed adjustable cam modules;

FIG. 2 is a side view of an adjustable cam module according to the invention;

FIG. 3 is a bottom view of the module of FIG. 2;

FIGS. 4A and 4B are perspective views of the base of the cam and the gear device of the adjustable cam module of FIG. 2, respectively;

FIG. 5 is a view of an optimized concept (second embodiment) of part of an adjustable cam module that can be locked in position;

FIGS. 6A and 6B are perspective views, for the second embodiment, of means for locking the cam and indexing means, and

FIG. 7 is a perspective view of another version of the embodiment of the module of FIG. 5.

### DETAILED DESCRIPTION

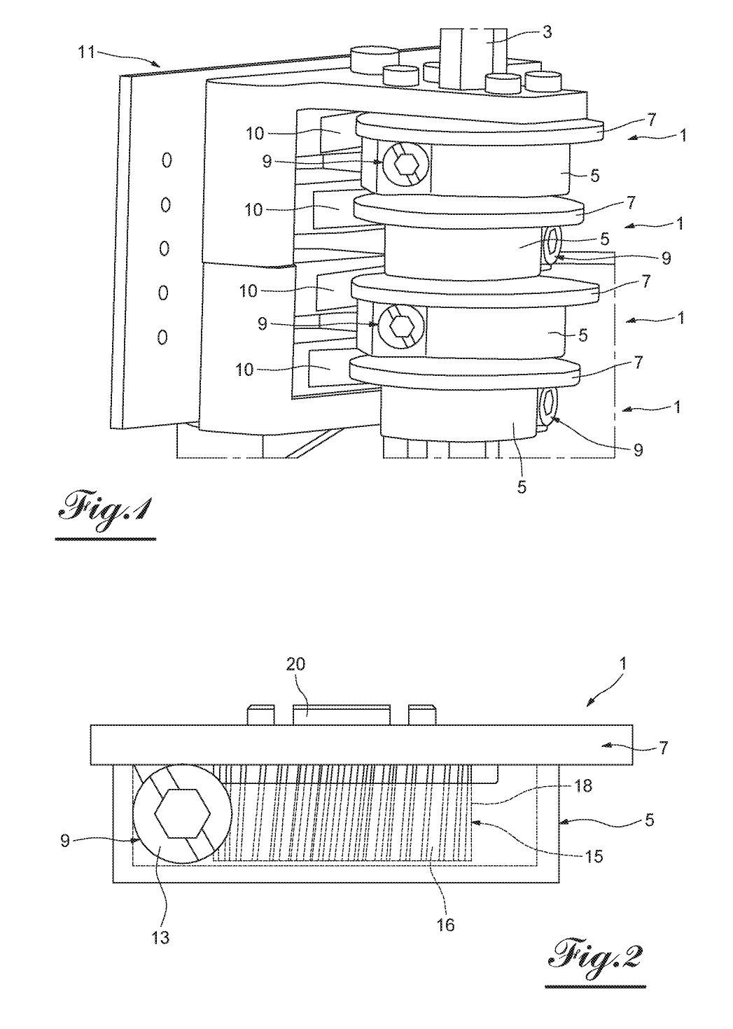

FIG. 1 shows, as a nonexclusive example, a system of four adjustable cam modules 1 according to the invention, which are stacked on a same rotating driveshaft 3.

Each module as shown in FIG. 2 comprises a base 5 secured in rotation with the shaft 3 and a cam disc 7 that is mounted on the base 5 whereof the angular position can be adjusted using a gear device 9. Each cam disc is intended to command an electric contact 10 of an exterior support structure 11. This gear device 9 essentially comprises a worm screw 13 mounted fixed in the base 5 and extending perpendicular to the shaft 3, and which meshes with a crown gear 15 concentric to the shaft 3 and secured in rotation with the cam disc 7. The teeth 16 of the crown 15 are slightly inclined relative to the direction of the axis of the shaft 3.

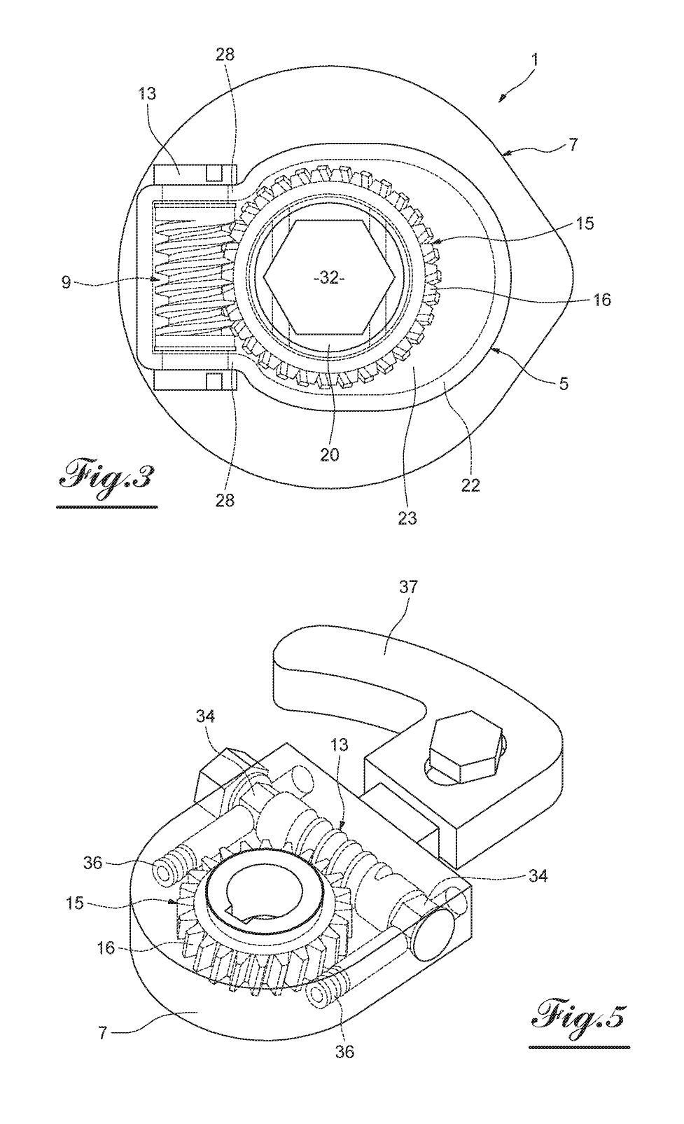

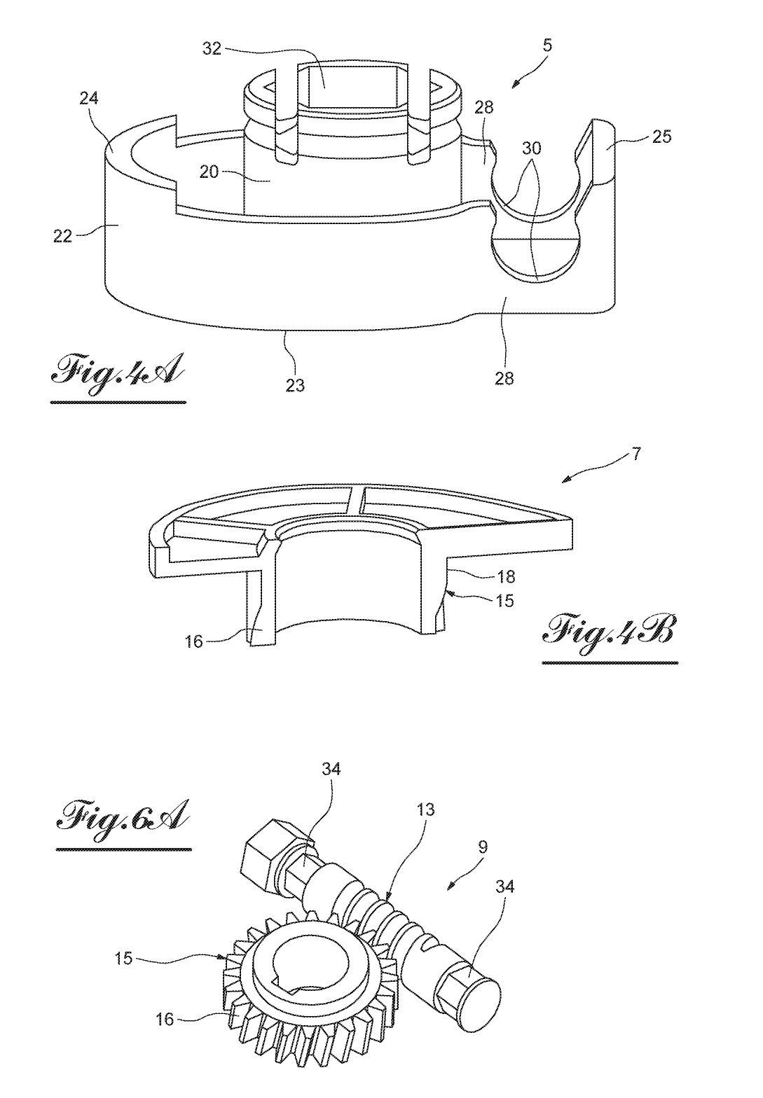

Referring in particular to FIGS. 4A and 4B, one can see that the cam disc 7 comprises a cylindrical end-piece 18 that protrudes perpendicular to the surface of the disc and is intended to engage on a complementary cylindrical end-piece 20 of the base 5. The crown gear 15 is arranged coaxially on the end-piece 18 of the cam disc 7 while being secured in rotation therewith, as in particular shown by FIGS. 2 and 3.

The worm screw 13 is thus secured to the base 5. The cam 7 is in motion relative to the base 5.

The base 5 is made in the form of an oval basin including side walls 22 that extend perpendicular from the bottom 23, as shown in FIG. 2. In its position mounted on the base, the disc bears on the free upper edge of the side wall 22 of the base, more specifically on raised parts 24, 25 of this wall that are situated at opposite portions relative to the axis and furthest away from one another. One can see that at the raised wall 25, the side wall is not rounded but, seen from above, has a U-shaped profile whereof the branches 28 are parallel. In each of these wall portions, a cutout 30 in the form of an arc of circle is made. These cutouts are intended to receive the worm screw 13 that extends, as indicated above, perpendicular to the drive shaft 3 of the base. The axis of this shaft is combined with the axis of the end-pieces 18 and 20 of the disc 7 and the base 5, respectively. The position of the screw is chosen such that it can mesh with the teeth 16 of the crown gear 15 such that rotating the screw causes the crown 15 and the cam disc 7 to rotate. The ends of the screw are, to that end, configured to allow rotational driving of the screw by a tool, such as a screwdriver. At least one end of the screw is therefore accessible from the outside. It should also be noted that the base is fastened on the shaft for example owing to a noncircular opening 32, for example hexagonal, in the bottom wall 23 of the base.

Owing to the incline of the threads of the screw and the teeth of the crown, when the cam is brought, by rotation of the screw, into a desired predetermined position, this position is ensured by a self-locking effect when the cam is subject to a resistance force, i.e., when the cam reaches the contact to be actuated.

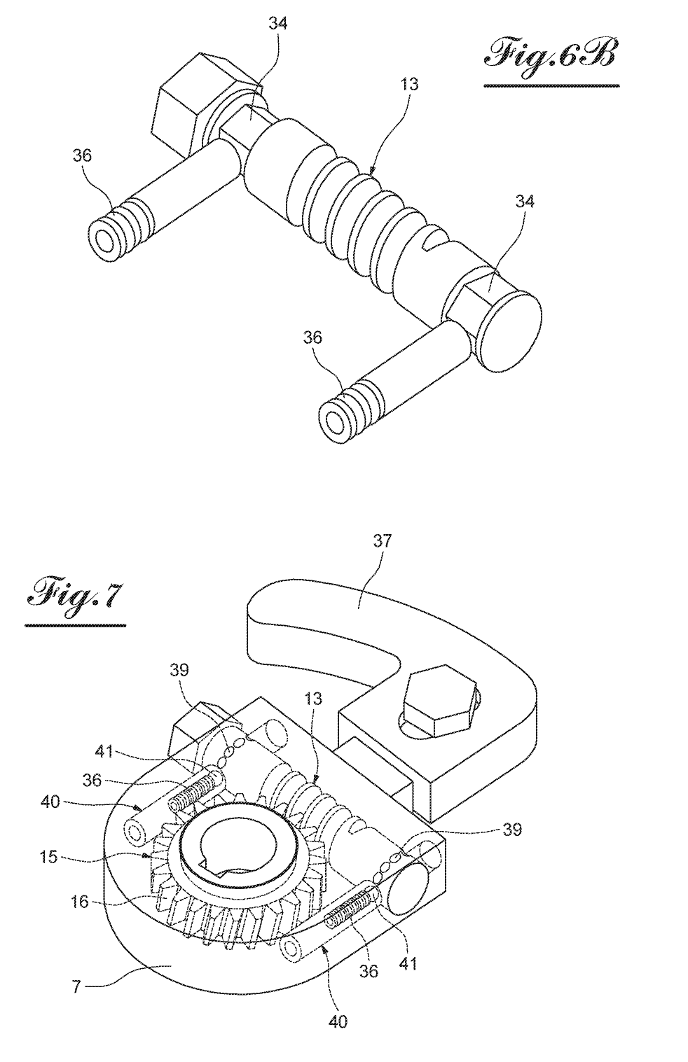

In the alternative embodiment of the invention shown in FIGS. 5, 6A and 6B, the worm screw 13 is secured to the cam 37, while the crown gear 15 is fixed.

The blocking of the position of the cam, after an adjustment, is ensured by specific blocking means clearly illustrated in FIG. 6B. To that end, the screw includes, at each end, i.e., on either side of the threaded part, a part with a multi-face cross-section, for example, hexagonal, and the module includes, associated with each of the two hexagonal portions 34, a spring 36 that bears by one end on a stop element (not shown) of the base and acts by its other end on one of the six faces of the part with a hexagonal section of the screw. Thus, the screw is kept in a desired angular position after a rotational adjustment of the screw, by the pressure exerted by the springs on the bearing face. In the figure, the faces on one side of the threaded part of the screw are angularly offset by 30° relative to the faces on the other side, which procures blocking as well as indexing in 12 positions. It should be noted, as mentioned above, that in FIG. 5, the crown gear 15 is secured in rotation with the axis 3 and the screw 13 is provided on the cam 7, which bears a contact control element 37.

FIG. 7 shows a module according to FIG. 5, but provided with another embodiment version of the means for blocking the position of the cam after an adjustment. In this version, the screw 13 comprises, on either side of its threaded part, a series of cavities 39 that are formed in the peripheral surface of the screw and angularly distributed thereon. Like in FIG. 5, the blocking means include two helical springs 36, each mounted in a maintaining element 40 and associated with a series of cavities, and provided at its end adjacent to the screw with a spherical element 41 intended to be removably engaged under the effect of the spring in a cavity, following an adjustment of the position of the cam. If applicable, by angularly offsetting the cavities of the two series, it is possible to double the number of indexing positions.

Of course, multiple modifications can be made to the embodiment of the invention described above as a non-limiting example. Thus, the configurations of the base and the cam with its crown can be different, as long as the worm screw or a similar member is kept as adjusting member, which allows easy actuation from the outside.

1. A control cam system including at least one moving cam module for controlling an actuator device, wherein the actuator device has an end-of-travel position which is adjustable using a gear device, wherein the moving cam module comprises
a base secured to and rotating with a rotating shaft, and
a cam mounted on and angularly adjustable in position on the base, wherein the gear device comprises a worm screw mounted on the base and meshing with teeth associated with the cam so that rotation of the worm screw causes a change in angular position of the cam on the base.

2. The system according to claim 1, including a crown gear secured to and rotating with the cam, wherein the worm screw is arranged in the base, perpendicular to the shaft driving rotation of the base, and meshes with the crown gear.

3. The system according to claim 1, wherein
the worm screw includes threads having a pitch, and
orientation of the teeth associated with the cam make an angular position of the cam, after an adjustment, irreversible.

4. The system according to claim 1, including means for blocking rotation of the worm screw in angular position and thereby locking the cam in an angular position.

5. The system according to claim 4, including a pusher element, wherein
the worm screw comprises a part with a multi-face cross-section and
the worm screw is blocked by action from the pusher element acting on a face of the multi-face cross-section.

6. The system according to claim 5, wherein the pusher element includes a compression spring having a first end bearing against a fixed stop and a second end bearing on a face of the worm screw.

7. The system according to claim 4, including a pusher element, wherein
the worm screw comprises cavities in a peripheral surface of the worm screw and which are angularly offset, and
the worm screw is blocked by engagement of the pusher element in one of the cavities.

8. The system according to claim 7, wherein the pusher element includes a compression spring having an end bearing, at the end, adjacent to the worm screw, a spherical element for engaging one of the cavities.

9. The system according to claim 1, wherein the cam is a disc having a cam-forming part at a periphery of the disc.

10. The system according to claim 1, comprising a plurality of the moving cam modules mounted on the rotating shaft.
